(19) United States
(12) Patent Application Publication
(10) Pub. No.: US 2005/0237708 A1
(43) Pub. Date: Oct. 27, 2005

(54) Hard disk drive mounting rack

(76) Inventor: Deng-Hsi Chen, Keelung (TW)

Correspondence Address: RABIN & BERDO, P.C., 1101 14 Street, N.W., Suite 500, Washington, DC, 20005, US

(21) Appl. No.: 10/829,428

(22) Filed: Apr. 22, 2004

(51) Int. Cl. G06F 1/16

(52) U.S. Cl. 361/685

(57) ABSTRACT

A hard disk drive mounting rack comprising two frame racks and several accompanied screws; the screws are installed onto the screws holes on both sides of HDD, the frame racks are fastened to the fastening holes of the metal case that is originally for the HDD racks. An inserting slot is on the front of the frame rack, the screws slide into the inserting slots of the frame racks; a switch is on the front of the frame rack, the switches are closed after the HDD is installed for fast replacement; the installation and dismantle is very convenient.

### BACKGROUND OF THE INVENTION

I. Field of the Invention

This invention relates generally to a mounting rack and, more specifically, to a hard disk drive mounting rack that consists of two frame racks and accompanying screws, the screws are installed directly to the screw holes of the HDD (Hard Disk Drive), the screws slide into the inserting slots on the frame racks for rapid replacement of HDD.

II. Description of the Prior Art

Heretofore, it is known that most of the hard disk drives are fixed on the HDD racks with screws, or, referring to FIG. 1, have a plastic external HDD storage box c on the HDD rack b of the metal case a. The known external HDD storage box c consists of a plastic box c1 and the corresponding plastic frames c2; the plastic frames c2 are fixed on two sides of the HDD rack b. The protruding stripes c11 on both sides of the plastic box c1 are inserted into the sliding slots c21 on both inner sides of the plastic frames c2 for convenient installation and dismantling; however this method must have an extra external HDD storage box c, the installation process take two procedures, not only inconvenient but also cost more.

### SUMMARY OF THE INVENTION

It is therefore a primary object of the invention to provide a hard disk drive mounting rack that offers convenient installation and dismantling of HDD and cost reduction of manufacturing.

In order to achieve the objective set forth, a hard disk drive mounting rack in accordance with the present invention comprises two frame racks and several accompanied screws. A hook each on the back of the frame racks are fastened to the fastening holes of the metal case that is originally for the HDD racks. An inserting slot is on the front of the frame rack; a switch is on the front of the frame rack. The accompanied screws are installed directly onto the screw holes on both sides of the HDD.

Based on the structure described above, the screws slide into the inserting slots of the frame racks for rapid replacement of HDD without another storage box; the HDD can be fixed onto the HDD rack of the computer case for more convenience and less manufacturing cost. The strengthening part design of the frame rack not only has elasticity but also with definite strength to absorb the vibration caused by the rotation of HDD.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

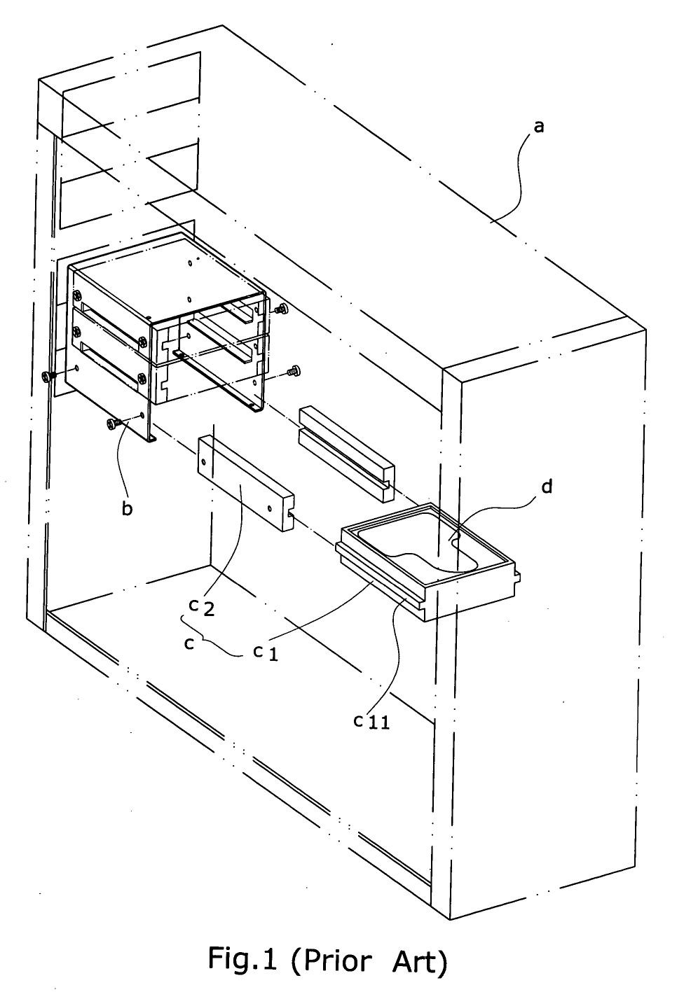

FIG. 2 is a perspective view of the present invention;

FIG. 3 is an assembly view of the present invention;

FIG. 4 is an application view of the present invention.

### DESCRIPTION OF THE PREFERRED EMBODIMENT

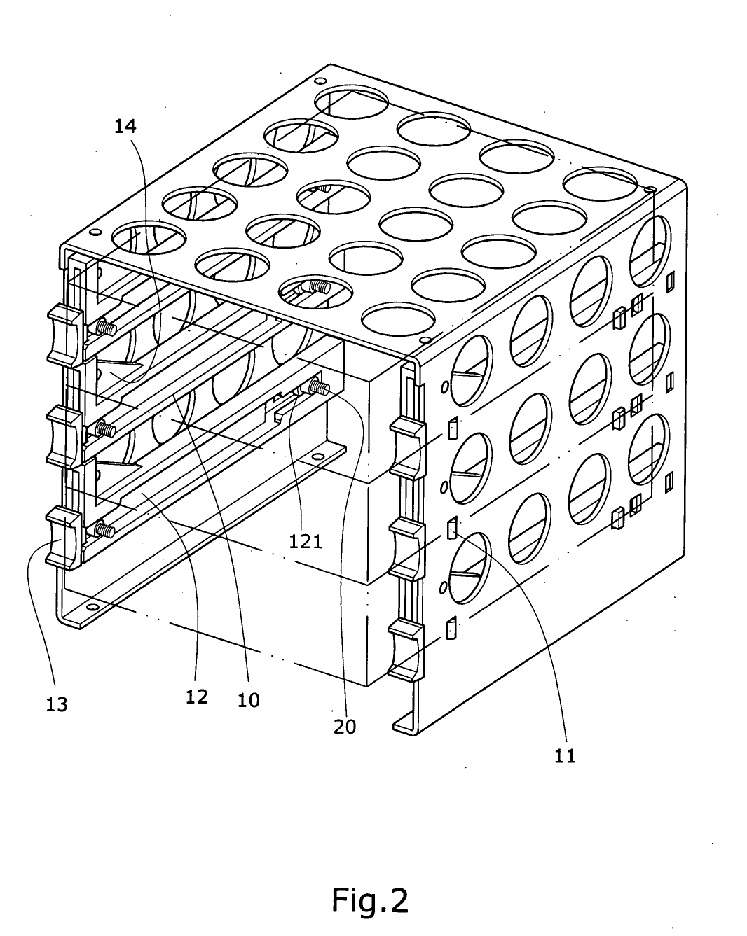

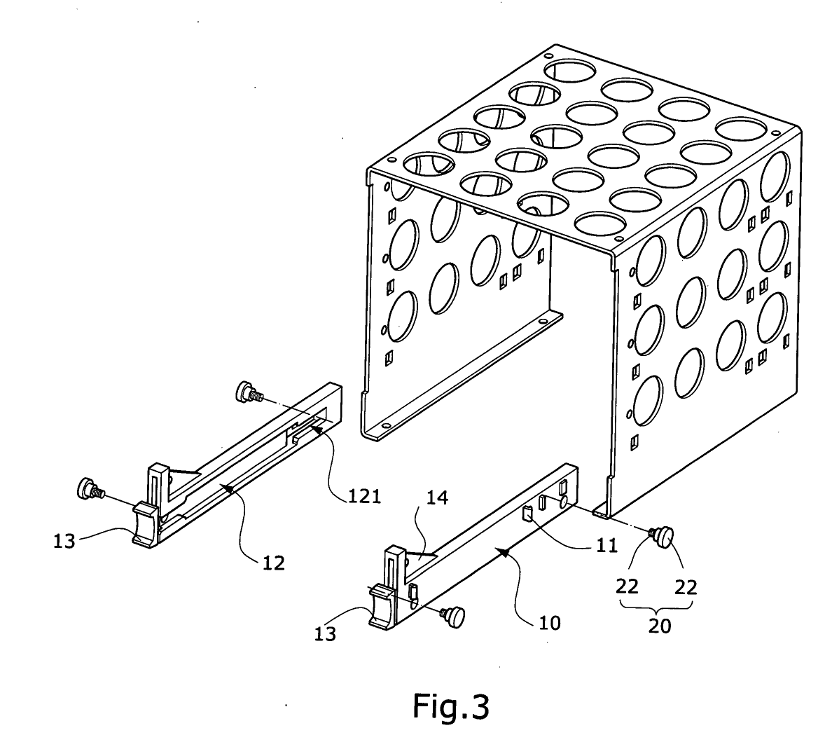

Referring to FIG. 2 and FIG. 3, the present invention comprises two frame racks 10 and several accompanied screws 20. The function of each component is described as following:

The frame racks 10 are made of plastic and injected into one body with a hook 11 on the back, an inserting slot 12 is on the front of the frame rack 10, a clipping slot 121 is on the end of the inserting slot 12; a switch 13 is on the front of the frame rack 10, a strengthening part 14 is on the top back of the switch 13 of the frame rack 10.

The screws 20 are made of metal with a flat sphere body 21 on front and threads 22 on the back.

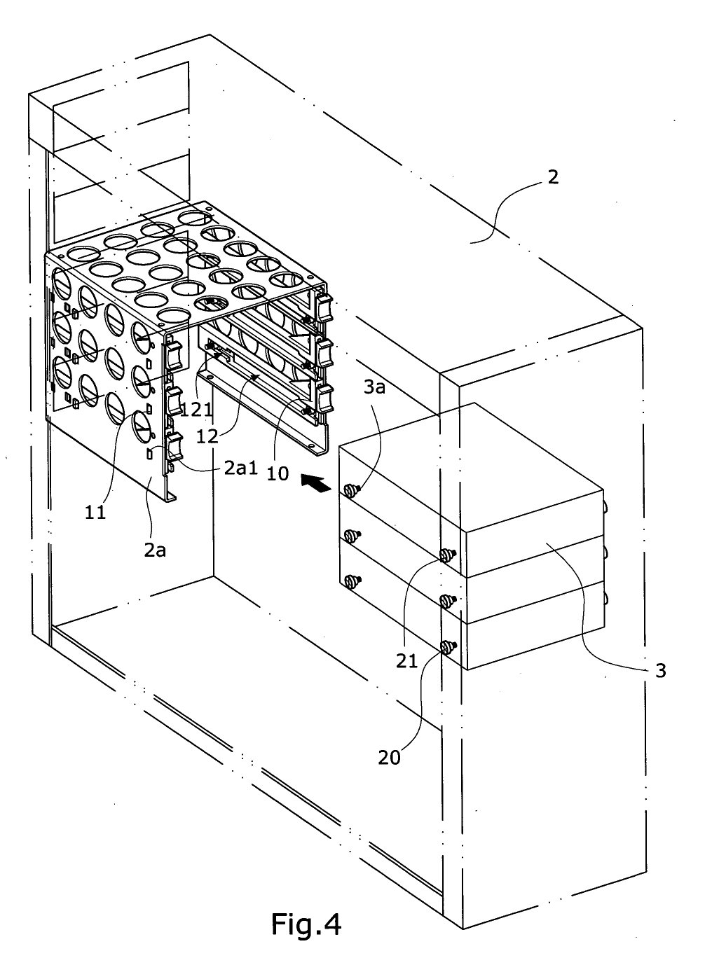

While assembly, referring to FIG. 4, the hooks 11 of the frame racks 11 are fastened to the fastening holes 2a1 of the metal case 2 that is originally for the HDD racks 2a. The screws 20 are installed onto the screw holes 3a on both sides of the HDD 3 to have the flat sphere caps 21 of the screws 20 slide into the back of the inserting slot 12 of the frame rack 10. After the screws 20 slide to the clipping slots 121, users can close the switch 13, the HDD 3 will not fall off to achieve fast replacement of the HDD3 purpose.

While a preferred embodiment of the invention has been shown and described in detail, it will be readily understood and appreciated that numerous omissions, changes and additions may be made without departing from the spirit and scope of the invention.

1. A hard disk drive mounting rack comprising:
two frame racks and several accompanied screws, said screws are installed onto the screw holes on both sides of the HDD, said frame racks are fastened to the fastening holes of the metal case that is originally for the HDD racks, an inserting slot is on the front of said frame rack, said screws slide into the inserting slots of said frame racks, a switch is on the front of said frame rack, said switches are closed after the HDD is installed for fast replacement.

2. The hard disk drive mounting rack recited in claim 1, wherein a hook is on the back of said frame rack, an inserting slot is on the front of said frame rack, a switch is on the front of said frame rack.

3. The hard disk drive mounting rack recited in claim 2, wherein a clipping slot is on the end of said inserting slot of said frame rack.

4. The hard disk drive mounting rack recited in claim 2, wherein a strengthening part is on the top back of said switch of said frame rack.

5. The hard disk drive mounting rack recited in claim 1, wherein said screws have a flat sphere body on the front and threads on the back.
